(19) United States
(12) Patent Application Publication
(10) Pub. No.: US 2006/0043872 A1
(43) Pub. Date: Mar. 2, 2006

(54) Electron emission device and fabricating method thereof

(76) Inventor: Kwang-Seok Jeong, Suwon-si (KR)

Correspondence Address: Robert E. Bushnell;Suite 300, 1522 K Street, N.W., Washington, DC, 20005, US

(21) Appl. No.: 11/207,885

(22) Filed: Aug. 22, 2005

(30) Foreign Application Priority Data
Aug. 30, 2004 (KR) 10-2004-0068523

(51) Int. Cl. H01J 1/62; H01J 63/04

(52) U.S. Cl. 313/495

(57) ABSTRACT

An electron emission device comprises: a first substrate and a second substrate which are positioned to face each other; cathodes formed on the first substrate; electron emitting regions electrically connected to the cathodes; an insulating layer formed on the first substrate and having openings for exposing the electron emitting regions; and gate electrodes formed on the insulating layer. The electron emitting regions include at least one porous alumina template formed on the cathodes, and the electron emitting regions are grown vertically in the porous alumina template. A method for fabricating the electron emission device includes forming a porous alumina template on the cathodes using anodic oxidation, and forming electron emitting regions by use of chemical vapor deposition while injecting a carrier gas and applying a voltage between the first substrate and the cathodes, and growing electron emitting material in the porous alumina template.

### CLAIM OF PRIORITY

This application makes reference to, incorporates the same herein, and claims all benefits accruing under 35 U.S.C. §119 from an application for ELECTRON EMISSION DEVICE AND FABRICATING METHOD THEREOF earlier filed in the Korean Intellectual Property Office on 30 Aug. 2004 and there duly assigned Serial No. 10-2004-0068523.

### BACKGROUND OF THE INVENTION

1. Technical Field

The present invention relates to an electron emission device and a fabricating method for the same, and more particularly, relates to an electron emission device that can control the spreading of electron beams by directly growing electron emitting regions perpendicularly to a substrate through a porous alumina template, and a method for fabricating the electron emission device.

2. Related Art

Generally, electron emission devices are of two types: those that use a hot cathode as an electron emission source, and those that use a cold cathode as an electron emission source. Among the known electron emission sources of the cold cathode type are a field emitter array (FEA) type, a metal-insulator-metal (MIM) type, a metal-insulator-semiconductor (MIS) type, and a ballistic electron surface emitter (BSE) type.

Electron emission devices have different structures according to their type but, basically, they form a structure for emitting electrons in a vacuum container and use the electrons emitted from the structure. In the case where the electron emission device includes a fluorescent layer in an electron beam path, it can function as a light emitting element or a display element. The FEA-type electron emission device forms an electron emitting region with a material that emits electrons when an electric field is applied to it, and it includes driving electrodes, such as a cathode and a gate electrode, around the electron emitting region. It takes advantage of a principle by which electrons are emitted when an electric field is formed around the electron emitting region due to a voltage difference between two electrodes. A typical structure of the FEA-type electron emission device includes cathodes, insulating layers, and gate electrodes formed on a substrate sequentially. An opening is formed in a gate electrode and an insulating layer in an area where each cathode crosses each gate electrode to expose part of the surface of the cathode, and then electron emitting regions are formed on top of the exposed cathode in the opening. In the initially suggested FEA-type electron emission device, the electron emitting regions are formed into a spindt-type having a sharp pointed end by depositing or sputtering molybdenum (Mo) under vacuum conditions. Related to the initial FEA-type electron emission device is an electric-field cold cathode fabricating method disclosed in U.S. Pat. No. 5,938,495 to Ito, entitled METHOD OF MANUFACTURING A FIELD EMISSION COLD CATHODE CAPABLE OF STABLY PRODUCING A HIGH EMISSION CURRENT, issued on Aug. 17, 1999. The spindt-type electron emitting regions are formed so as to have a bottom diameter of about 0.5 μm and a height of about 0.5 to 1 μm. Since the fabrication of an electron emission device having spindt-type electron emitting regions should employ a known semiconductor fabrication method, the fabrication process is complicated and requires highly difficult technology. Therefore, the production cost is high and it is difficult to produce a large-sized product.

To solve the problems, a recent research trend in the electron emission device field is to develop a method for forming electron emitting regions through a known film growing process, such as a screen printing, by using carbon-based materials having a low work function, e.g., carbon nanotube (CNT), graphite, and diamond-like carbon. Since the electron emitting regions have an electron emitting material, i.e., a carbon-based material, on their exposed surfaces, they can easily emit electrons at a low voltage, and they can be easily fabricated. Therefore, this method is advantageous for producing a device of large size.

Electron emission devices form the electron emitting regions though a process of screen printing, drying, and firing. Therefore, the electron emitting material is not exposed on the surface but is buried in solid powder, thereby lowering electron emitting efficiency. To solve this problem, electron emission devices go through a surface treatment process in which the electron emitting material is exposed by attaching adhesive tape to the electron emitting structure, and removing part of the surface where the electron emitting regions are located by detaching the tape. Also, since the electron emitting regions are formed by being used in a paste state, the electron emitting material is distributed randomly, which causes electron beam spreading.

### SUMMARY OF THE INVENTION

It is an aspect of the present invention to provide an electron emission device that can control the spreading of the electron beam so that the electrons emitted from the electron emitting region do not collide with structures, including insulating layers and electrodes, and a method for fabricating the electron emission device.

It is another aspect of the present invention to provide an electron emission device which comprises: a first substrate and a second substrate which are positioned to face each other; cathodes formed on the first substrate; electron emitting regions electrically connected to the cathodes; an insulating layer formed on the first substrate so as to have an opening for exposing the electron emitting regions on the first substrate; and gate electrodes formed on the insulating layer. The electron emitting regions include at least one porous alumina template formed on the cathodes, and the electron emitting regions are grown vertically in the porous alumina template.

It is yet another aspect of the present invention to provide a method for fabricating an electron emission device, the method comprising the steps of: (a) forming cathodes on a substrate; (b) forming an insulating layer to cover the cathodes over the entire substrate; (c) forming gate electrodes on the insulating layer, the gate electrodes having at least one opening in each area where a gate electrode crosses a cathode; (d) forming a porous alumina template on the cathodes by performing anodic oxidation (anodizing) on the cathodes while using the gate electrodes as masks so as to expose only the cathods; and (e) forming electron emitting regions by connecting the porous alumina template to a chemical vapor deposition (CVD) reactor, injecting a carrier gas containing hydrocarbon into the CVD reactor while applying a voltage between the first substrate and the cathodes, and directly growing electron emitting material vertically in the porous alumina template on the cathodes.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a cross-sectional view of an electron emission device in accordance with an embodiment of the present invention;

FIG. 2 is a cross-sectional view of electron emitting regions in accordance with an embodiment of the present invention;

FIG. 3 is a scanning electron microscopic (SEM) picture showing the electron emitting regions in accordance with the embodiment of the present invention; and

FIGS. 4A and 4E are cross-sectional diagrams of a method for fabricating an electron emission device in accordance with an embodiment of the present invention.

### DETAILED DESCRIPTION OF THE INVENTION

In the following detailed description, embodiments of the invention are shown and described simply by way of illustrating the best mode contemplated by the inventors for carrying out the invention. As will be realized, the invention is capable of modification in various respects, all without departing from the invention. Accordingly, the drawings and description should be regarded as illustrative in nature, and not as restrictive.

The present invention relates to an electron emission device that can control electron beam spreading, which is caused by collision of the electrons emitted from conventional electron emitting regions against structures, such as insulating layers and electrodes, by using a porous alumina template, and by directly growing electron emitting regions perpendicularly to a substrate, and a method for fabricating the electron emission device.

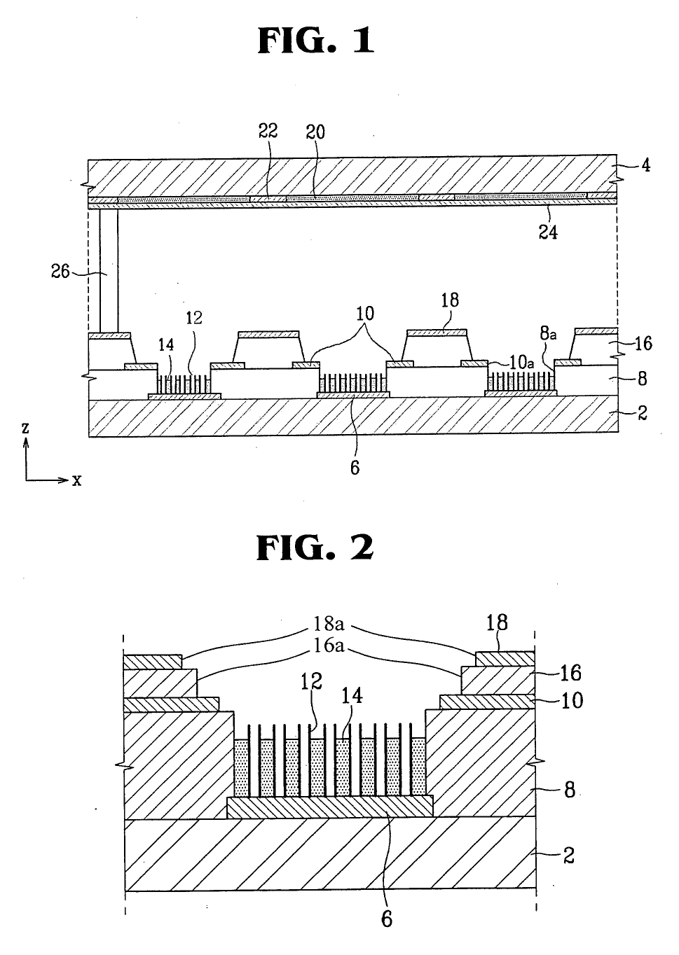

FIG. 1 is a cross-sectional view of an electron emission device in accordance with an embodiment of the present invention.

Referring to FIG. 1, an electron emission device forms a vacuum container, which is an exterior frame of the electron emission device, by positioning a first substrate 2 and a second substrate 4, each having a predetermined size, in parallel and spaced apart from each other to thereby form an internal space between the two substrates, and by joining the first substrate 2 and second substrate 4. The first substrate 2 is provided with a structure for emitting electrons, and the second substrate 4 is provided with a light emitting region for emitting visible rays by means of electrons to thereby realize a predetermined image.

To be specific, a plurality of cathodes 6 having a predetermined pattern, for example, a stripe pattern, are formed on the first substrate 2, and are spaced apart from each other along a direction of the first substrate 2, which is a y-axial direction in the drawing, and a first insulating layer 8 is formed to cover the cathodes 6 over the entire first substrate 2. On top of the first insulating layer 8, a plurality of gate electrodes 10 are formed spaced apart from each other and extending in a direction so as to cross the cathodes 6, that is, extending in a direction perpendicular to the x-3 plane shown in the drawing.

If the area where the cathodes 6 and the gate electrodes 10 cross each other is defined as a pixel area in the embodiment of the present invention, at least one electron emitting region 12 is formed on a cathode 6 in each pixel area. In the first insulating layer 8 and the gate electrodes 10, openings 8a and 10a corresponding to the electron emitting regions 12 are formed to expose the electron emitting regions 12 on the first substrate 2.

In the electron emission device of the present invention, the electron emitting regions 12 are not formed evenly on a cathode in the opening, as suggested in conventional methods, but they are formed on the cathode 6 by being directly grown on the cathode 6.

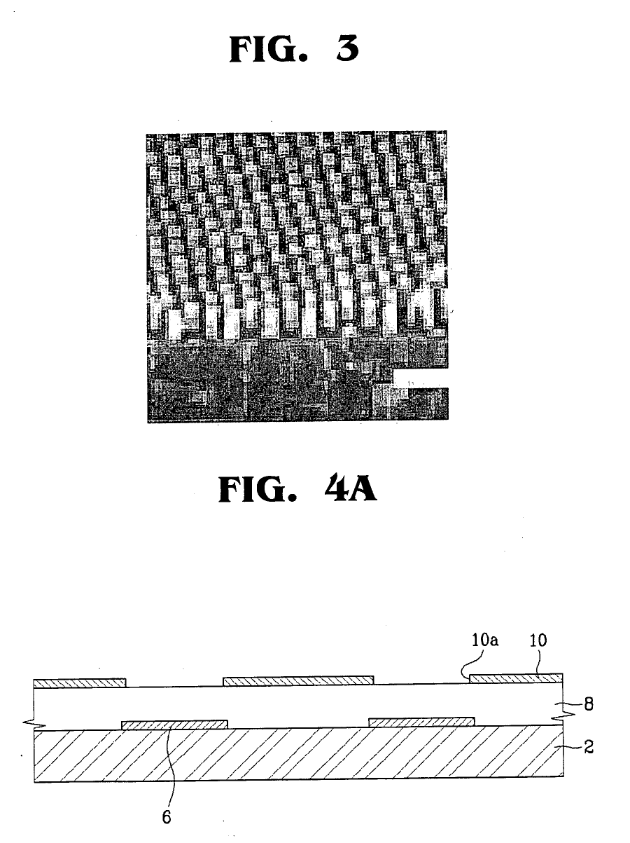

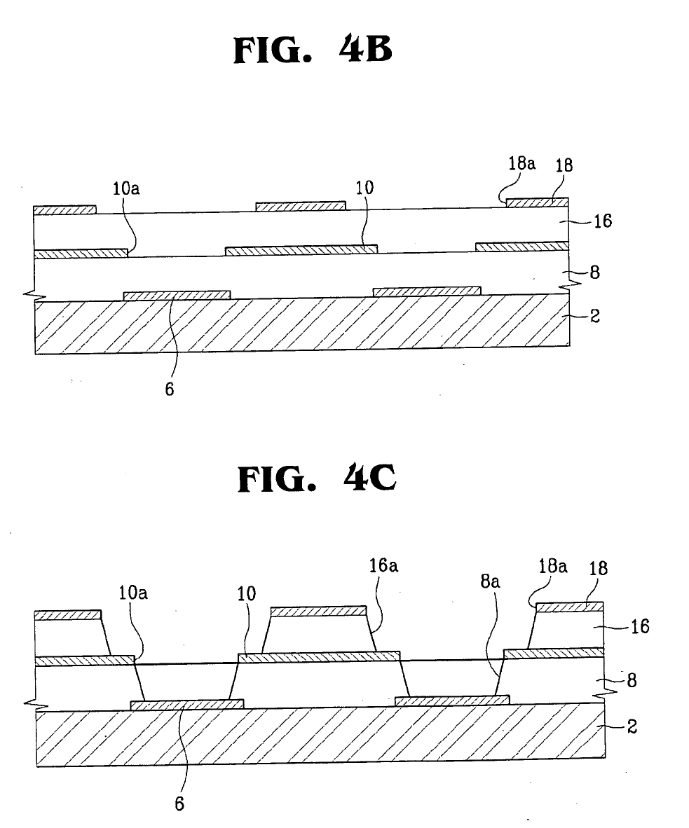

FIG. 2 is a cross-sectional view of electron emitting regions in accordance with an embodiment of the present invention, and FIG. 3 is a scanning electron microscopic (SEM) picture showing the electron emitting regions in accordance with the embodiment of the present invention.

In FIG. 2, the electron emitting regions 12 are directly grown in a porous alumina template 14 formed on the cathode 6 so as to be distributed perpendicularly to the cathode 6.

The porous alumina template 14 is formed by performing anodic oxidation on the cathode 6 which is formed of an aluminum thin film. The porous alumina template 14 has pores of nano-meter size. The pore size of the porous alumina template 14 is in proportion to the amplitude of the applied voltage. The diameter of the electron emitting regions 12 grown in the porous alumina template 14 is the same as the pore size of the porous alumina template 14. Therefore, the diameter of an electron emitting region 12 can be controlled by adjusting the pore size of the porous alumina template 14.

A method of directly growing the electron emitting regions 12 is performed on the cathode 6 in accordance with a chemical vapor deposition (CVD) method. The length of the electron emitting regions 12 is controlled by the CVD treatment time and the thickness of the porous alumina template 14. Herein, the thickness of the porous alumina template 14 can be controlled by the anodic oxidation reaction time of the cathode 6.

Other than the first insulating layer, the electron emission device of the present invention further includes a second insulating layer for covering the gate electrodes over the entire substrate, and focus electrodes formed on the first insulating layer and the gate electrodes, with the second insulating layer being disposed therebetween.

To be specific, the second insulating layer 16 and the focus electrodes 18 can be formed on the gate electrodes 10 and the first insulating layer 8, and openings 16a and 18a are formed on the second insulating layer 16 and the focus electrodes 18 to expose the electron emitting regions 12. Herein, the openings 16a and 18a on the second insulating layer 16 and the focus electrodes 18, respectively, are provided for each pixel area set up on the first substrate 2, and the openings 16a and 18a are formed so as to surround a plurality of electron emitting regions 12.

The opening 16a of the second insulating layer 16 and the opening 8a of the first insulating layer 8 are formed by sequential patterning of the second insulating layer 16 and the first insulating layer 8. In that regard, patterning is carried out in accordance with a general photolithography method. Also, the first insulating layer 8 is etched by an etching solution or an etching gas at an etching rate more than three times that of the second insulating layer 16.

Subsequently, fluorescent layers 20 of red, green, and blue, for instance, are formed 6n one side of the second substrate 4, that is, the side facing the first substrate 2, with a predetermined spacing therebetween. Between the fluorescent layers 20 of each color, a black layer 22 can be formed to improve contrast of the screen. On top of the fluorescent layers 20 and the black layer 22, a metal film (for example, an aluminum film) can be deposited to form an anode 24. The anode 24 receives a voltage for accelerating an electron beam from the outside, and increases the brightness of the screen by providing a metal back effect.

Meanwhile, the anode 24 can be formed of a transparent conductive film, such as an indium tin oxide (ITO) film, instead of the metal film. Herein, a transparent anode (not shown) is formed on top of the second substrate 4 first, and then the fluorescent layers 20 and the black layer 22 are formed thereon. If necessary, a metal film is formed on the fluorescent layers 20 and the black layer 22 to improve the brightness of the screen. The anode is formed over the entire second substrate 4, or it can be formed in a plurality of units of a predetermined pattern.

In FIG. 1, reference numeral ‘26’ is a spacer that maintains a predetermined space between the first substrate 2 and second substrate 4. Although FIG. 2 presents only one spacer, there are a plurality of spacers between the first substrate 2 and second substrate 4.

When a predetermined level of driving voltage is applied to the cathode 6 and the gate electrode 10, the electron emission device having the above described structure forms an electric field around the electron emitting regions 12, which are distributed vertically, and emits electrons due to the voltage difference between the cathode 6 and the gate electrode 10. The emitted electrons are forced and converged by the voltage, for example, dozens of volts of negative voltage, applied to the focus electrode 18 so as to move in a direction such that the divergent angle becomes small. The emitted electrons are attracted by the high voltage applied to the anode 24, and they move toward the second substrate 4 to thereby collide with the fluorescent layer 20 of a corresponding pixel and emit light.

Herein, the electron emission device of the present embodiment can converge the electric field of the electron emitting regions 12 by forming the electron emitting regions 12 perpendicularly to the cathodes 6, and thus it controls the electron beam spreading phenomenon. Since electrons can be emitted easily out of the electron emitting region 12, the emission efficiency of the electron emitting regions 12 is increased and the driving voltage can therefore be decreased.

The electron emission device of the present embodiment that provides vertically distributed electron emitting regions 12 can minimize the quantity of electrons that are consumed by colliding with the first insulating layer 8 and second insulating layer 16, thereby charging the first insulating layer 8 and second insulating layer 16, or leaked by colliding with the gate electrodes 10. Since the electrons are emitted toward the second substrate 4 with a regular straightness, there are advantages in that color infringement can be minimized and color reproducibility on the screen becomes high.

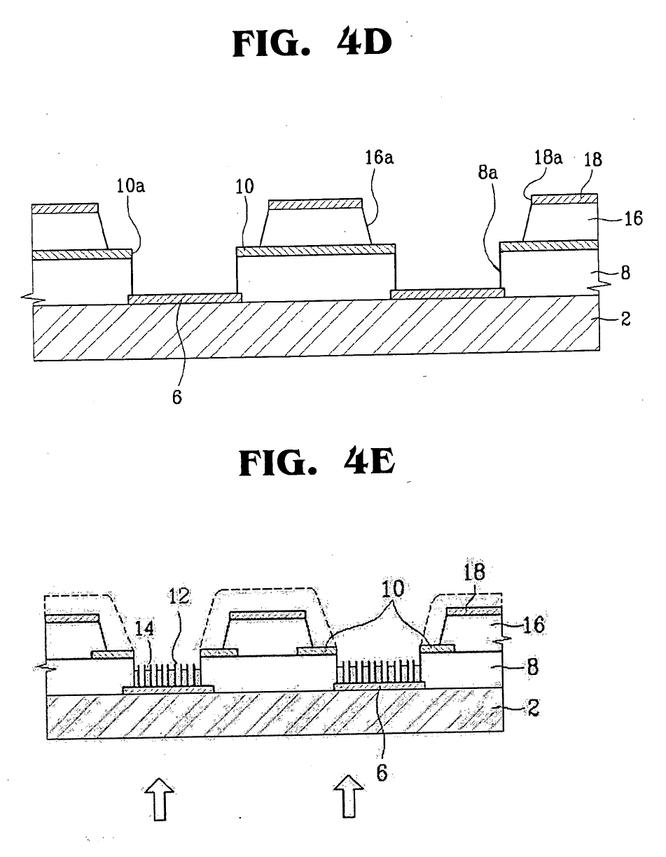

FIGS. 4A and 4E are cross-sectional diagrams of a method for fabricating an electron emission device in accordance with an embodiment of the present invention.

First, as shown in FIG. 4A, cathodes 6 are formed in a stripe pattern along a direction of the first substrate 2, and a first insulating layer 8 is formed to cover the cathodes 6 over the entire first substrate 2. The first insulating layer 8 can be formed with a thickness of about 5 to 30 μm by repeating a process of screen printing, drying, and firing.

Subsequently, gate electrodes 10 are formed on the first insulating layer 8 in a stripe pattern and in such a direction that the gate electrodes 10 cross the cathodes 6. The gate electrodes 10 include at least one opening 10a in each pixel area, i.e., an area in which a gate electrode 10 crosses a cathode 6.

As illustrated in FIG. 4B, a second insulating layer 16 is formed on top of the first insulating layer 8 and the gate electrodes 10. The second insulating layer 8 can also be formed with a thickness of about 5 to 30 μm by repeating the process of screen printing, drying, and firing. Then, focus electrodes 18 having an opening 18a are formed by coating and patterning a conductive material on the second insulating layer 16.

As described in FIGS. 4C and 4D, the openings 16a and 8a are formed by patterning the second insulating layer 16 and the first insulating layer 8 sequentially. The first insulating layer 8 and the second insulating layer 16 are patterned in a film growing process through a general photolithography method so as to form the openings 8a and 16a. Each of the first insulating layer 8 and the second insulating layer 16 can be formed of a material having a different etching rate, and can be etched with an etching solution or an etching gas to thereby form each opening.

As shown in FIG. 4E, a porous alumina template 14 is formed on the cathodes 6 on top of the first substrate 2, and the electron emitting regions 12 are formed by growing electron emission sources perpendicularly in the porous alumina template 14.

The porous alumina template 14 can be formed by performing masking with a photoresist after the formation of the cathode substrate structure, exposing only the cathodes 6, in which the electron emitting regions 12 are to be formed, by using the gate electrodes 10 as masks, and performing anodic oxidation on the cathodes 6. The anodic oxidation of the cathodes 6 is carried out by impregnating the first substrate 2 with the exposed cathodes 6 in an electrolyte solution, and applying a voltage to the first substrate 2 and the cathodes 6.

The cathodes 6 are formed of an aluminum thin film, and the aluminum thin film exposed to the electrolyte solution goes through the anodic oxidation to thereby form nanometer-sized pores. The porous aluminum thin film is the porous alumina template 14. The electrolyte solution is formed of oxalic acid.

The electron emitting regions 12 of the present invention are formed through a process of connecting the resultant structure, which is obtained through the above process, with a chemical vapor deposition (CVD) reactor (not shown), injecting a carrier gas containing hydrocarbon into the CVD reactor while applying a voltage between the substrate and the cathodes 6, and growing the electron emitting material perpendicularly in the porous alumina template 14 formed on the cathodes 6.

As for the CVD method, the widely known plasma CVD method or thermal CVD method can be used. The plasma CVD method is one in which glow discharge is induced in a chamber or a reactor by applying high-frequency power to the two electrodes. For example, when a carbon nanotube is synthesized, reaction gases such as C₂H₂, CH₄, C₂H₄, and CO are used, and catalytic metals such as Fe, Ni, and Co are deposited on Si, SiO₂ or on a glass substrate through a thermal deposition method or a sputtering method. The catalytic metal deposited on the substrate is etched by using ammonia and hydrogen gas so as to form nanometer-sized fine catalytic metal particles. When the reaction gas is supplied to the chamber and high frequency power is applied to both electrodes, glow discharge is induced and carbon-based material, such as carbon nanotube, is synthesized from the fine catalytic metal particles on the substrate.

The thermal CVD method includes the steps of depositing Fe, Ni, Co, or an alloy of the three catalytic metals on the substrate as a catalytic metal, etching the substrate with hydrofluoric acid diluted with water, loading the etched sample on a quartz boat and inserting the quartz boat into the CVD reactor, and forming nanometer-sized fine catalytic metal particles by additionally etching the catalytic metal film with NH₃ gas. The carbon nanotube can be synthesized on the fine catalytic metal particles. Also, it is preferable that the electron emitting regions 12 be grown by performing the CVD method at a temperature of under 600° C.

The electron emitting materials that form the electron emitting regions 12 are largely divided into carbon-based materials and nanometer-sized materials. Examples of carbon-based materials are carbon nanotube, graphite, diamond-like carbon, and fullerene (C₆O). Examples of the nanometer-sized materials are carbon nanotube, graphite nanofiber, and silicon nanowire.

The following examples further illustrate the present invention in detail, but they are not to be construed as limiting the scope thereof.

### COMPARATIVE EXAMPLE 1

10 g carbon nanotube (CNT), 1 g glass frit, and 2 g inorganic binder resin were mixed to prepare a first mixture. Then, 10 g photosensitive monomer, 5 g optical initiator, 10 g terpineol as a solvent, and 50 g acrylate resin as an organic binder resin were mixed to obtain a vehicle. Subsequently, a paste composition was prepared by mixing and agitating the first mixture and the vehicle. The paste composition was screen-printed on the cathodes of a first substrate by using a printer, and was then subjected to a thermal treatment at 90° C. for 10 minutes. The result of this process was then exposed to a mirror reflected parallel beam illuminator (MRPBI) with a light exposure energy of 10 to 20,000 mJ/cm², and was developed by using an alkali developing solution in a spay method. A firing process in a furnace at 550° C. was then conducted to obtain a carbon nanotube layer. Subsequently, the carbon nanotube layer was subjected to a surface treatment by attaching adhesive tape to the carbon nanotube layer, and then detaching the tape vertically.

### EXAMPLE 1

A porous alumina template having nanometer-sized pores was formed on a substrate with cathodes formed thereon by impregnating the cathode substrate in an oxalic acid electrolyte solution and performing anodic oxidation by applying a voltage. Herein, gate electrodes were used as masks.

Subsequently, the porous alumina template was connected to a chemical vapor deposition (CVD) reactor, and electron emitting regions were formed by injecting a carrier gas containing hydrocarbon into the CVD reactor while applying a voltage between the substrate and the cathode to directly grow electron emitting material perpendicularly in the porous alumina template on the cathode. Herein, carbon nanotube was used as the electron emitting material.

The electron emission device of the present invention has electron emitting regions directly grown in the porous alumina template on the substrate, and completely distributed vertically on the substrate. Since electrons emitted from the electron emitting regions do not collide with other structures, such as insulating layers or electrodes, it is possible to control the spreading of the electron beam and to increase the quantity of electron emission.

While the present invention has been described with respect to certain preferred embodiments, it will be apparent to those skilled in the art that various changes and modifications may be made without departing from the scope of the invention as defined in the following claims.

What is claimed is:

1. An electron emission device, comprising:
a first substrate and a second substrate which are positioned to face each other;
cathodes formed on the first substrate;
electron emitting regions electrically connected to the cathodes;
an insulating layer formed on the first substrate and having openings for exposing the electron emitting regions; and
gate electrodes formed on the insulating layer;
wherein the electron emitting regions include at least one porous alumina template formed on the cathodes, and wherein the electron emitting regions are grown vertically in the porous alumina template.

2. The electron emission device of claim 1, wherein the porous alumina template is formed vertically by applying a voltage to the first substrate and to the cathodes, and performing anodic oxidation on the cathodes.

3. The electron emission device of claim 1, wherein the cathode comprises an aluminum thin film.

4. The electron emission device of claim 1, wherein a diameter of the electron emitting regions is the same as a pore size of said at least one porous alumina template.

5. The electron emission device of claim 1, wherein the electron emitting regions are formed of at least one selected from the group consisting of carbon nanotube, graphite, diamond-like carbon, fullerene, graphite nanofiber, and silicon nanowire.

6. The electron emission device of claim 1, further comprising at least one anode formed on the second substrate and fluorescent layers formed on a first side of the anode.

7. The electron emission device of claim 6, wherein said at least one anode and the fluorescent layers are formed on a side of the second substrate facing the first substrate.

8. The electron emission device of claim 1, further comprising an additional insulating layer disposed on the gate electrodes for covering the gate electrodes over an entirety of the first and second substrates, and focus electrodes formed on the additional insulating layer.

9. A method for fabricating an electron emission device, comprising the steps of:
(a) providing a substrate;
(b) forming cathodes on the substrate;
(c) forming an insulating layer to cover the cathodes over an entirety of the substrate;
(d) forming gate electrodes on the insulating layer;
(e) forming a porous alumina template on the cathodes; and
(f) forming electron emitting regions by directly growing electron emitting material in the porous alumina template on the cathodes.

10. The method of claim 9, wherein said gate electrodes are formed so as to have at least one opening in each area where a gate electrode crosses a cathode.

11. The method of claim 9, wherein the porous alumina template is formed on the cathodes by performing anodic oxidation on the cathodes while using the gate electrodes as masks so as to expose only the cathodes.

12. The method of claim 11, wherein the anodic oxidation of the cathodes is carried out by impregnating the substrate with the exposed cathodes in an electrolyte solution and applying a voltage to the substrate and the cathodes.

13. The method of claim 12, wherein the electrolyte solution comprises oxalic acid.

14. The method of claim 9, wherein the electron emitting regions are formed by connecting the porous alumina template to a chemical vapor deposition (CVD) reactor, injecting a carrier gas containing hydrocarbon into the CVD reactor while applying voltage between the first substrate and the cathodes, and then directly growing electron emitting material vertically in the porous alumina template on the cathodes

15. The method of claim 9, wherein the electron emitting regions are grown by performing chemical vapor deposition (CVD) at a temperature of less than 600° C.

16. The method of claim 9, wherein a diameter of the electron emitting regions is controlled by adjusting a pore size of the porous alumina template.

17. The method of claim 9, wherein the electron emitting regions comprise at least one selected from the group consisting of carbon nanotube, graphite, diamond-like carbon, fullerene, graphite nanofiber, and silicon nanowire.

18. The method of claim 9, further comprising the steps of:
forming an additional insulating layer on top of the insulating layer and the gate electrodes;
forming focus electrodes having openings on the additional insulating layer; and
patterning the insulating layer and the additional insulating layer to form openings therein.

19. The method of claim 9, wherein the electron emitting material is grown vertically in the porous alumina template.
